(19) United States
(12) Patent Application Publication
(10) Pub. No.: US 2024/0246301 A1
(43) Pub. Date: Jul. 25, 2024

(54) DYNAMIC INDUCTION WELDING INSTALLATION

(71) Applicants: INSTITUT DE RECHERCHE TECHNOLOGIQUE JULES VERNE, Bouguenais (FR); NANTES UNIVERSITE, Nantes (FR)

(72) Inventors: Didier TRICHET, Saint-Nazaire (FR); Mansor NDIAYE, Saint-Nazaire (FR); Huu Kien BUI, Saint-Nazaire (FR); Antoine PIERQUIN, Saint-Herblain (FR)

(21) Appl. No.: 18/564,285

(22) PCT Filed: May 24, 2022
(86) PCT No.: PCT/EP2022/063992

§ 371 Date: Jan. 22, 2024

(30) Foreign Application Priority Data
May 25, 2021 (FR) FR2105414

(51) Int. Cl. B29C 65/36; B29C 65/00

(52) U.S. Cl. CPC B29C 65/3656; B29C 66/43441; B29C 66/721; B29C 66/742

(57) ABSTRACT

A dynamic induction welding installation for welding first and second workpieces in a weld zone (S), the second workpiece being placed between a lightning protection system and the first workpiece, the workpieces including a composite material, the installation having an induction heating device placed on one side of the first workpiece facing away from the second workpiece and configured to create a magnetic field (Bi) so as to form the weld in the weld zone (S), and a medium placed in contact with the lightning protection system on a side opposite to the second workpiece, the medium being configured so as to be capable of generating a reaction magnetic field (B₂) at least partially opposing the magnetic field (B₁) in at least a part of the lightning protection system.

### TECHNICAL FIELD

The present invention relates to a dynamic induction welding installation, which is preferably contactless, for induction welding two parts made of composite material comprising a thermoplastic polymer material. The invention also relates to a welding process using this installation. This installation and this process can be implemented in the context of welding parts, notably large parts, that are intended for the aeronautics sector but also for the automotive sector, wind power sector or any other industrial sector.

### PRIOR ART

In order to fix one part, such as a stiffener, to another part, such as a skin, it is known to make holes and insert rivets. Such a technique, however, is not optimum because it requires the production of local reinforcements to compensate for the mechanical losses caused by the through-holes.

Another technique consisting in putting the parts in an autoclave for several hours, for example 8h, in order to consolidate them by causing their matrix to melt so as to join the parts together is known. However, this technique increases the treatment time and the energy necessary to carry it out, and is not easy to implement for large parts.

Furthermore, composite materials having a thermoplastic polymer matrix are increasingly being used in industrial fields, in particular for their advantageous mechanical properties.

To join two parts made of composite material having a thermoplastic polymer matrix, it is conceivable to weld them to one another. This is because, by contrast to rivets, producing a weld makes it possible to retain the mechanical properties of the parts.

In order to weld the two parts together, the interface between the parts where the weld is to be produced is brought to a temperature allowing the two parts to melt at this interface.

The use of an induction heating process using an inductor makes it possible to correctly increase the temperature at the interface between the two parts. However, it is necessary to focus the induction heating on the interface between the two parts without adversely affecting the adjacent portions.

When one of the parts is up against a lightning strike protection system, also referred to as “LSP”, for example for an aircraft fuselage, it becomes even more complex to focus the induction heating on the interface between the two parts. This is because the inductor generates overheating of the lightning protection system without allowing the interface between the parts to reach a temperature high enough for the heating.

US2020223153 describes a process for joining overlapping thermoplastic membrane components using an electrically conductive metal susceptor.

DE102008044208 presents a device for welding two components, between which a plastics material is partially introduced.

There is therefore a need for a dynamic induction welding installation and process that make it possible to facilitate the welding of a part made of composite material comprising a thermoplastic polymer material to a second part made of composite material comprising a thermoplastic polymer material, one of the parts being up against a lightning protection system.

### DISCLOSURE OF THE INVENTION

The present invention meets this need according to one of its aspects by virtue of a dynamic induction welding installation for welding a first and a second part to one another in a welding zone, the second part being disposed between a lightning protection system and the first part, the first and second parts each comprising a composite material comprising reinforcing fibers and a thermoplastic polymer matrix, the installation having:
an induction heating device, which is disposed on a side of the first part that is opposite the second part and is configured to create a magnetic field so as to produce the weld in the welding zone, and
a support disposed in contact with the lightning protection system on a side thereof that is opposite the second part, the support being configured to make it possible to create a reaction magnetic field at least partially opposing the magnetic field created by the induction heating device in at least one portion of the lightning protection system.

“Create a reaction magnetic field at least partially opposing the magnetic field created by the heating device” is understood to mean that the superposition of the magnetic field induced by the support and the magnetic field of the induction heating device forms a reduced magnetic field in at least one portion of the lightning protection system. Such superposition results from the extensive character of the magnetic fields, that is to say from the fact that the magnetic fields are added together.

When the installation is operating, the induction heating device creates a variable magnetic field at least partially passing through the first part, the second part and the lightning protection system, in the welding zone, that is to say in the surrounding area of the welding zone, in particular above and below it, along an axis which is perpendicular to the longitudinal axis of the first part and passes through the first part, the second part, the lightning protection system and the support, this axis possibly corresponding to a vertical axis.

This variable magnetic field leads to the formation of variable induced currents in the reinforcing fibers which will then heat up by the Joule effect. The heat from the reinforcing fibers is then transferred to the matrix which heats up in turn until it melts, so as to allow welding at the interface between the parts.

By contrast to rivets, welding makes it possible to retain the mechanical properties of the first part.

However, the variable magnetic field also leads to the formation of variable induced currents in the lightning protection system, which will then heat up by the Joule effect.

By virtue of the invention, owing to the at least partial opposition of the magnetic fields created respectively by the induction heating device and the support, the formation of induced currents in at least one portion of the lightning protection system is at least partially canceled, preferably 50% canceled, better at least 70% canceled, better still at least 90% canceled. As a result, the Joule effect in at least one portion of the lightning protection system is limited, thereby reducing the increase in temperature of the latter.

The reaction magnetic field of the support is advantageously created passively, that is to say without introducing additional energy, in reaction to the magnetic field of the induction heating device.

The support has at least one active layer, configured to make it possible to create the reaction magnetic field at least partially opposing the magnetic field created by the induction heating device in at least one portion of the lightning protection system.

Said active layer preferably does not contribute to the introduction of heat for producing the weld.

The support preferably has multiple layers of materials at least partially superposed on one another, notably at least one thermal insulation layer and said at least one active layer. In a particular embodiment, the support has at least three layers, for example exactly three layers, including at least one active layer sandwiched between two thermal insulation layers.

Said at least one thermal insulation layer may be made of a non-magnetic and non-electrically conductive material, for example a composite material based on glass fibers of the E60 or E70 type, preferably being machinable.

At least one thermal insulation layer of the support may be in contact with the lightning protection system. This thermal insulation layer may have a thickness of between 0.1 mm and 3 mm.

Said at least one thermal insulation layer may make it possible to ensure good contact between the support and the lightning protection system and may make it possible to react mechanical forces, notably compressive forces, applied to said parts while they are being welded. Said at least one thermal insulation layer is preferably resistant to mechanical stresses and resistant to temperature fields.

Said at least one active layer may have a thickness of between 1 and 10 mm.

The support, notably the active layer, may comprise a material having a relative magnetic permeability of between 1 and 1000.

The support, notably the active layer, may comprise a material having an electrical conductivity of between 10⁶ and 10⁸ S·m⁻¹.

When the support, notably the active layer, comprises a magnetic and/or electrically conductive material, the magnetic field of the induction heating device promotes the creation of induced currents, referred to as Foucault currents, in the support, notably in the active layer. These currents then generate the reaction magnetic field, the direction of which is counter to the magnetic field created by the induction heating device.

The support, notably the active layer, may comprise a material selected from the family of metals, notably copper, steel, notably stainless steel, whether magnetic or non-magnetic, bronze or a metal alloy comprising one or more of these metals. Such a material of the support is advantageously selected to obtain an electrical conductivity adapted to the nature of the lightning protection system, that is to say to its composition or to its shape.

The support may form a single-layer or multilayer, preferably multilayer, mat having a total thickness of between 5 mm and 500 mm.

The support advantageously has a width and length greater than or equal to those of the welding zone, the width and the length of the support preferably being at least equal to those of the lightning protection system.

The mat forming the support may consist of a sheet extending substantially parallel to at least one portion of the second part.

The first part and the second part may comprise the same reinforcing fibers and/or the same thermoplastic polymer matrix.

The reinforcing fibers of the first and second parts may be continuous fibers. They are advantageously selected from the group consisting of carbon fibers and metal fibers.

The thermoplastic polymer of the matrix may be selected from the group consisting of the family of polyaryletherketones (PAEK), notably polyetheretherketone (PEEK) or polyetherketoneketone (PEKK).

The first part may consist of a stiffener. The first part may have an L-shaped cross section having a core and a flange to be welded to the second part, the core and the flange being connected by a bent portion with an angle of between 60° and 120°, notably between 75° and 105°, preferably equal to approximately 90°.

The installation may have a punch designed to support the core at least during the welding. Such a punch may be in contact with the core over at least some of the height of the latter, or even over the entire height of the latter, on a side of the core that is opposite that facing the induction heating device.

The lightning protection system may be made of at least one conductive material, notably copper, bronze or aluminum, and preferably forms a mesh with a thickness of between 0.1 mm and 0.2 mm. The lightning protection system may be disposed in contact with the second part, preferably over its entire surface area and parallel thereto, and in contact with the support, notably in contact with at least one thermal insulation layer of the support.

The second part may form a skin with a thickness of between 1 400 μm and 10 000 μm and may have, toward the first part, a notably planar face to be welded which at least partially forms the welding zone.

The induction heating device may operate using alternating currents up to 2000 A and frequencies lower than 500 kHz. For example, the heating device may be selected from among inductors sold by Fives Celes or by CEIA or else by EFD.

### Dynamic Welding Process

Another subject of the invention, according to another of its aspects, in combination with the preceding text, is a process for dynamic induction welding a first and a second part to one another, the second part being disposed between the first part and a lightning protection system, the process being implemented using an installation as defined above and comprising the following steps consisting in:
positioning the first part to be welded against the second part, such that the induction heating device is disposed on that side of the first part that is opposite the second part,
creating a magnetic field using the induction heating device so as to produce a weld at the interface between the first and the second part in the welding zone, the power of the induction heating device being adapted to allow the reaction magnetic field created by the support to compensate the magnetic field in at least one portion of the lightning protection system, notably located in the welding zone.

The power of the induction heating device is preferably less than 12 kW. In the present invention, the power necessary to weld said parts is much lower than that necessary in the event of welding in an autoclave according to the prior art.

The process may comprise the prior step consisting in predetermining the parameters of the support, such as the nature of the material and/or its dimensions, notably its thickness and/or its length, by digital simulation so as to optimize them on the basis of the configuration of the first and second parts and the lightning protection system.

Specifically, the magnetic fields must be controlled very precisely and appropriately, the aim being to reach the melting temperature of the thermoplastic polymer matrix at the interface between the two parts. Not doing this runs the risk of destroying or at least adversely affecting one of the parts or the parts and/or the lightning protection system, at least in part, and/or having a poor-quality weld or a weld of uncontrolled quality. In particular, the reaction magnetic field must attenuate the magnetic field of the heating device in order to limit the heating in the lightning protection system without excessively attenuating the magnetic field of the heating device in the welding zone so as to be able to produce a good-quality weld.

The process may comprise the prior step consisting in predetermining the power of the induction heating device for producing the weld, on the basis of the support, the nature of the first and second parts and/or the lightning protection system.

The induction heating device is preferably moved above the welding zone, at a distance from the first part, to produce the weld.

### BRIEF DESCRIPTION OF THE DRAWINGS

The invention will be able to be better understood from reading the following detailed description of non-limiting exemplary implementations thereof, and from examining the appended drawing, in which:

FIG. 1 schematically shows a cross section through one example of a dynamic welding installation according to the invention,

FIG. 2 shows the support of the installation of FIG. 1 on its own,

FIG. 3 shows a block diagram illustrating various steps of one example of a dynamic welding process according to the invention implementing the installation of FIG. 1,

FIG. 4 is a schematic graph illustrating the heating power in the first and the second part and in the lightning protection system while an installation or the process according to the invention is being implemented,

FIG. 5 is a schematic thermal map in the parts made of composite material having a thermoplastic matrix, in the lightning protection system and in the support while the process according to the invention is being implemented,

FIG. 6 is a enlarged view of detail VI of FIG. 5,

FIG. 7 is a schematic graph illustrating the heating power in the first and the second part and in the lightning protection system with an installation not in accordance with the invention,

FIG. 8 is a schematic thermal map in the parts made of composite material having a thermoplastic matrix, in the lightning protection system and in the support when welding using an installation not in accordance with the invention,

FIG. 9 is a enlarged view of detail IX of FIG. 8, and

FIG. 10 illustrates a final part obtained using the process and the installation according to the invention.

### DETAILED DESCRIPTION

In the rest of the description, elements which are identical or have identical functions bear the same reference sign. For the sake of conciseness of the present description, they are not described with regard to each of the figures; only the differences between the embodiments are described.

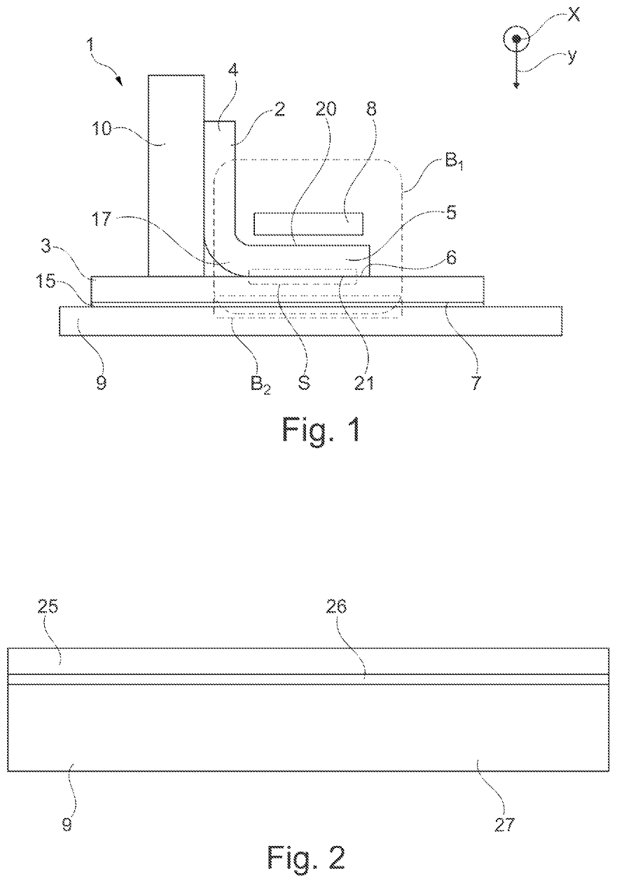

FIG. 1 illustrates a dynamic induction welding installation 1 according to the invention.

The installation 1 is intended for welding a first part 2 to a second part 3 in a welding zone S located at the interface between the first part 2 and the second part 3.

The first and second parts 2 and 3 are both made of composite material. They comprise reinforcing fibers, in this example continuous carbon fibers, and a thermoplastic polymer matrix, in this example made of polyetheretherketone (PEEK). Still in this example, the first part 2 and the second part 3 are made by stacking plies, also referred to as laminate, notably having long oriented carbon fibers, with a total thickness between 2 and 3 cm, the first part 2 having seven plies in this example and the second part 3 having eleven plies.

In the present case, the first part 2 is a stiffener, has an L-shaped cross section and extends longitudinally along a longitudinal axis X.

The first part 2 thus has a core 4 and a flange 5, which is that portion of the first part 2 that is to be welded to the second part 3. The core 4 is connected to the flange 5 by a bent portion 17, the angle between the core 4 and the flange 5 at the bent portion 17 being equal to approximately 90° in this example. The flange 5 is in contact with a face 6 to be welded of the second part 3. The thickness of the flange 5 is preferably between 1 400 μm and 3 000 μm, in this example is equal to 2 000 μm.

The second part forms a flat sheet, also referred to as skin, with a thickness of preferably between 1 400 μm and 10 000 μm, in this example being equal to 5 000 μm.

The second part 3 is disposed between the first part 2 and a lightning protection system 15, which in this example comprises a copper mesh with a thickness of 0.1 mm. The lightning protection system 15 extends against a surface 7 opposite the face 6 to be welded of the second part 3, parallel to and in contact with this opposite surface 7.

The installation 1 comprises an induction heating device 8, which can also be referred to as an inductor, disposed on that side of the first part 2 that is opposite the second part 3 at a distance from the first part 2, without contact therewith. In this example, the induction heating device 8 is thus disposed by a free surface 20 of the first part 2, opposite to a face 21 to be welded of the first part 1.

In this example, the faces 6 and 21 to be welded are flat and form the welding zone (S), in the portions where these faces 6 and 21 to be welded are in mutual contact.

The induction heating device 8 used in the example illustrated is sold under the name CELES MP12KW by Fives Celes. This induction heating device 8 is configured to create a variable magnetic field B₁, illustrated schematically in FIG. 1, which notably passes through the first part 2, the second part 3 and the lightning protection system 15.

In this example, the induction heating device 8 operates using alternating currents up to 2000 A and frequencies lower than 500 kHz.

The installation 1 also comprises a support 9 on which the lightning protection system 15 is disposed in contact therewith on a side which faces the second part 3, as can be seen.

The support 9 thus bears the assembly of the first part 2, the second part 3 and the lightning protection system 15, which are superposed along the y direction perpendicular to the longitudinal axis X.

The support 9 is configured so as to make it possible to create a reaction magnetic field B₂, illustrated schematically in FIG. 1, which at least partially opposes the magnetic field B₁ created by the induction heating device 8 in at least one portion of the lightning protection system 15.

As illustrated in FIG. 2, the support 9 in this example comprises an active layer 26 sandwiched between a first thermal insulation layer 25 and a second thermal insulation layer 27.

In this example, the two thermal insulation layers 25 and 27 are made of composite material having glass fibers of the E60 type.

The thermal insulation layer 25 of the support 9 in this example is in contact with the lightning protection system 15. In this example, this thermal insulation layer 25 has a thickness of 3 mm.

The active layer 26 in this example has a thickness of 1 mm and comprises a metal alloy with a relative magnetic permeability of between 1 and 1000 and with an electrical conductivity of between 10⁶ and 10⁸ S·m⁻¹.

This active layer 26 makes it possible to create the reaction magnetic field B₂. In this example, the support 9 forms a mat extending substantially parallel to the second part 3, and has a thickness substantially identical to the thickness of the second part 3 and a length and width greater than those of the welding zone S and approximately equal to those of the lightning protection system 15.

The material and the dimensions of the support 9 are selected so as to make it possible to obtain an electrical conductivity adapted to the nature of the lightning protection system 15, that is to say to its composition and to its shape.

The installation 1 in this example also comprises a punch 10, which is designed to support the core 4 at least during the welding and is disposed against the core 4 on the side opposite that facing the induction heating device 8.

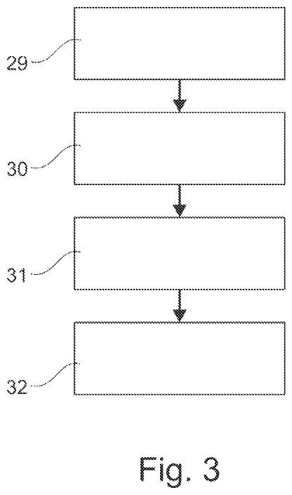

The steps of one example of a process, according to the invention, for dynamic welding of the first part 2 and the second part 3 in the welding zone S, using the installation 1, are illustrated in FIG. 3.

The process comprises a step 31 consisting in positioning the first part 2 against the second part 3, such that the induction heating device 8 is disposed on that side of the first part 2 that is opposite the second part 3.

In a step 32, to produce the weld at the interface between the first part 2 and the second part 3, a magnetic field B₁ is created using the induction heating device 8 so as to produce a weld at the interface between the first and the second part 2, 3. The power of the induction heating device 8 is adapted to allow the reaction magnetic field B₂ created by the support 9 to compensate the magnetic field B₁ in at least one portion of the lightning protection system 15.

In this example, during step 32, the induction heating device 8 is moved at a continuous speed, in a direction parallel to the longitudinal axis X of the first part 2, in order to weld the first part 2 and the second part 3 over the entire length of the first part 2.

As illustrated in FIG. 3, the process also comprises a prior step 29 consisting in predetermining the parameters of the support 9, such as the nature of the material and/or its dimensions, notably its thickness and/or its length, by digital simulation so as to optimize them on the basis of the configuration of the first and second parts 2 and 3 and the lightning protection system 15. Specifically, it is necessary to adapt the support 9 to the parts to be welded and to the lightning protection system 15, notably on the basis of their materials and their shapes, which can influence the magnetic field B₁ of the induction heating device 8.

The process may also comprise a prior step 30 consisting in predetermining the power of the induction heating device for producing the weld, on the basis of the support 9, the nature of the first and second parts 2 and 3 and the lightning protection system 15.

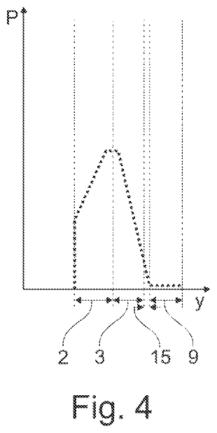

The heating power P transmitted by the installation 1 into the first part 2, the second part 3, the lightning protection system 15 and the support 9 underneath the induction heating device 8 in a direction y orthogonal to the longitudinal axis X and normal to the face 21 to be welded is illustrated in FIG. 4. As can be seen, the heating power P in the lightning protection system 15 is relatively low, this greatly limiting the extent to which it heats up.

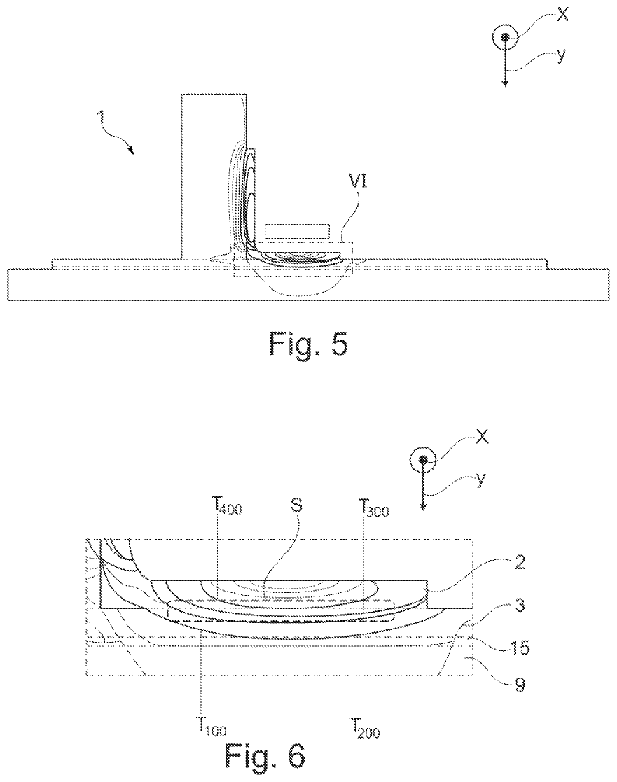

As can be seen in FIGS. 5 and 6, which illustrate the same temperatures at 100° C. T₁₀₀, at 200° C. T₂₀₀, at 300° C. T₃₀₀ and at 400° C. T₄₀₀ in a thermal map during the induction welding using the installation 1, the temperature in the lightning protection system is less than 100° C.

However, the temperature in the welding zone S is greater than 300° C. At this temperature, the thermoplastic matrices of the flange 5 and of the second part 3 are molten at their interface.

The at least partial opposition of the reaction magnetic field B₂, created by the support 9 in the installation 1 according to the invention, to the magnetic field B₁ created by the induction heating device 8 makes it possible to at least partially cancel the formation of induced currents in the lightning protection system 15, in this example by at least 90%.

As a result, in this configuration and for a given point in the welding zone S, the temperature at this given point will increase as the induction heating device 8 gets closer, until the thermoplastic polymer matrices of the first and second parts 2 and 3 are allowed to enter a molten state at this given point. When the induction heating device 8 moves away from the given point in the welding zone S, the temperature decreases until the matrices enter a solid state. They are then fused and thus welded at the given point. Furthermore, the temperature in the lightning protection system 15 during the welding does not exceed 100° C. by virtue of the formation of the reaction magnetic field B₂ formed by the support 9.

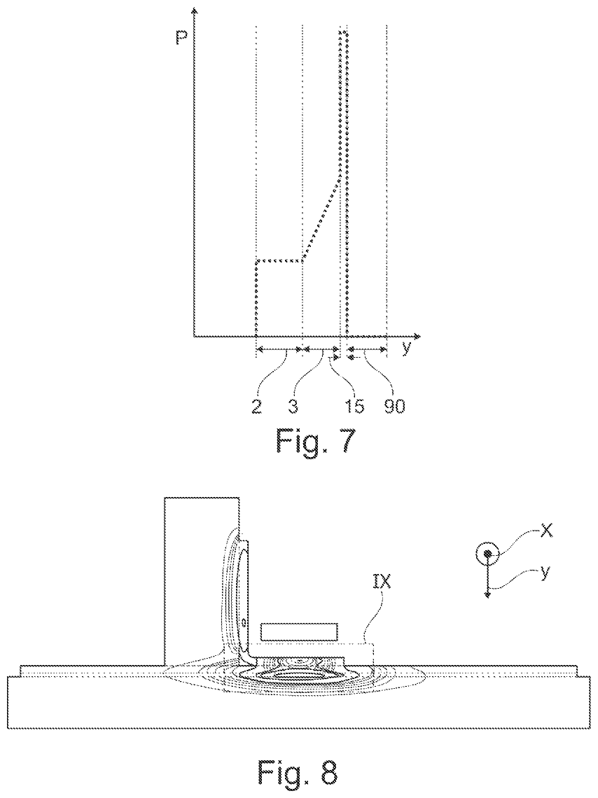

By way of comparison, FIG. 7 illustrates a graph illustrating the heating power P underneath the induction heating device 8 in an installation not in accordance with the invention, that is to say similar to that of the invention but not comprising a support 9, but instead a support 90 which itself does not make it possible to create a reaction magnetic field. It is then observed that the heating power P in the lightning protection system 15 underneath the induction heating device 8 is very high and broadly greater than the heating power P in the first part 2 or in the second part 3.

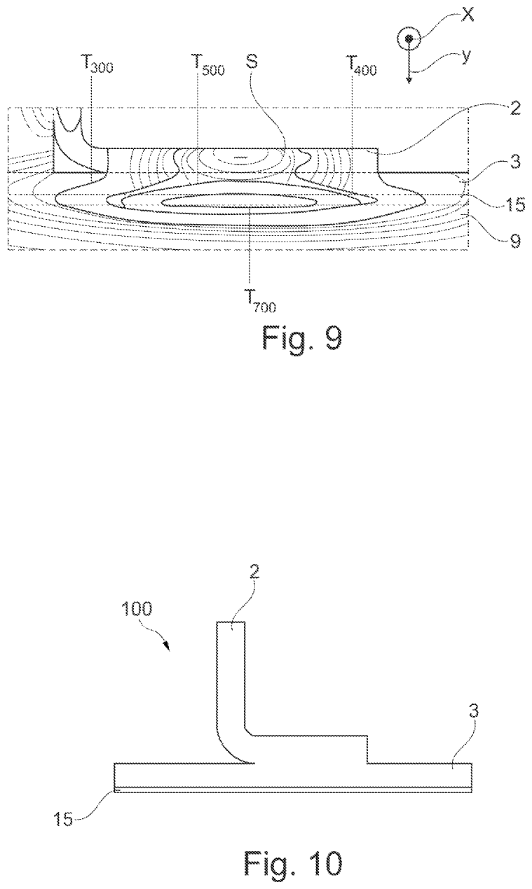

FIGS. 8 and 9 illustrate, for such an installation not in accordance with the invention, the same temperatures at 300° C. T₃₀₀, at 400° C. T₄₀₀, at 500° C. T₅₀₀ and at 700° C. T₇₀₀ for a thermal map during the welding.

As can be seen, the induction heating leads to local temperatures in the lightning protection system 15 during the welding that are greater than 700° C. and can reach 800° C., whereas the temperature in proximity to the welding zone S is greater than 300° C. This overheating risks damaging the lightning protection system 15 and the second part 3 and/or not producing an acceptable weld. This high temperature observed in the lightning protection system 15 is partially explained by the presence of Foucault currents in the lightning protection system 15.

When the induction heating device 8 has swept all of the welding zone S, along the longitudinal axis X, and when the weld has been produced, the punch 10 can be removed from the final part 100, as illustrated in FIG. 10.

The final part 100 comprises the first part 2, welded to the second part 3 in the welding zone, and the lightning protection system 15, up against the second part 3 on the side opposite the first part 2.

The invention is not limited to the example that has just been described.

The support may be made from another material, notably another electrically conductive material or a magnetic material.

The speed of the induction heating device 8 may be different, notably variable, or even zero.

The first part 2 and the second part 3 can have different geometries, thicknesses and/or fibers.

The first part 2 and the second part 3 may be made differently, notably of a non-laminated composite material, may comprise short fibers or comprise particles.

1. A dynamic induction welding installation for welding a first and a second part to one another in a welding zone (S), the second part being disposed between a lightning protection system and the first part, the first and second parts each comprising a composite material comprising reinforcing fibers and a thermoplastic polymer matrix, the installation having:
an induction heating device, which is disposed on a side of the first part that is opposite the second part and is configured to create a magnetic field (B₁) so as to produce the weld in the welding zone (S), and
a support disposed in contact with the lightning protection system on a side thereof that is opposite the second part, the support being configured to make it possible to create a reaction magnetic field (B₂) at least partially opposing the magnetic field (B₁) created by the induction heating device in at least one portion of the lightning protection system.

2. The installation as claimed in claim 1, wherein the support has at least one thermal insulation layer and at least one active layer.

3. The installation as claimed in claim 1, wherein the support has a relative magnetic permeability of between 1 and 1000.

4. The installation as claimed in claim 1, wherein the support comprises a material having an electrical conductivity of between 10⁶ and 10⁸ S·m⁻¹.

5. The installation as claimed in claim 1, wherein the support comprises a material selected from the family of metals, notably copper, steel, notably stainless steel, whether magnetic or non-magnetic, bronze or a metal alloy comprising one or more of these metals.

6. The installation as claimed in claim 1, the support forming a single-layer or multilayer, preferably multilayer, mat having a total thickness of between 5 mm and 500 mm and a width and length greater than or equal to those of the welding zone.

7. The installation as claimed in claim 1, wherein the first part has an L-shaped cross section having a core and a flange to be welded to the second part, the core and the flange being connected by a bent portion with an angle of between 60° and 120°.

8. The installation as claimed in claim 1, the lightning protection system being made of at least one conductive material forming a mesh with a thickness of between 0.1 mm and 0.2 mm, the lightning protection system being disposed in contact with the second part.

9. The installation as claimed in claim 1, the second part forming a skin with a thickness of between 1,400 μm and 10,000 μm and having, toward the first part, a notably planar face to be welded which at least partially forms the welding zone (S).

10. A dynamic induction welding process for induction welding a first and a second part to one another, the second part being disposed between the first part and a lightning protection system, the method being implemented using an installation as claimed in any one of the preceding claims and comprising the following steps consisting in:
positioning the first part to be welded against the second part, such that the induction heating device is disposed on that side of the first part that is opposite the second part,
creating a magnetic field (B₁) using the induction heating device so as to produce a weld at the interface between the first and the second part in the welding zone(S), the power of the induction heating device being adapted to allow the reaction magnetic field (B₂) created by the support to compensate the magnetic field (B₁) in at least one portion of the lightning protection system.

11. The process as claimed in claim 10 comprising the prior step consisting in predetermining the parameters of the support.

12. The process as claimed in claim 10, comprising the prior step consisting in predetermining the power of the induction heating device for producing the weld, on the basis of the support, the nature of the first and second parts and/or the lightning protection system.
